(19) United States
(12) Patent Application Publication
(10) Pub. No.: US 2011/0181392 A1
(43) Pub. Date: Jul. 28, 2011

(54) REAL TIME LOCATING SYSTEM, READER, RFID TAG AND DRIVING METHOD OF RFID TAG FOR LOCATING

(75) Inventors: Jong Sub CHA, Daejeon (KR); Sang Hyun Mo, Daejeon (KR); Heyung Sub Lee, Daejeon (KR)

(73) Assignee: Electronics and Telecommunications Research Institute, Daejeon (KR)

(21) Appl. No.: 12/694,893

(22) Filed: Jan. 27, 2010

(51) Int. Cl. G08B 5/22

(52) U.S. Cl. 340/8.1

(57) ABSTRACT

Provided are a real-time locating systems, a reader, an RFID tag and a driving method of the RFID tag for locating. The locating system includes an RFID tag, a plurality of readers, and a location processor. The RFID tag outputs a first or second transmission message frame according to whether value added information exists. The readers are disposed at different locations, receive and analyze the first or second transmission message frame to transmit extracted information and reception time information corresponding to the extracted information to a location processor. The location processor analyzes the information which is extracted through the readers and the reception time information to calculate location information or the value added information related to the RFID tag.

### TECHNICAL FIELD

The following disclosure relates to a real time locating system, a reader, a Radio Frequency Identification (RFID) tag and a driving method of the RFID tag for locating.

### BACKGROUND

RFID is a device or a technology that stores information necessary for all processes until a desired product is supplied from a production stage to the ultimate consumer in a tag attached to the product, thereby enabling to connect with other information systems.

Recently, RFID technology is variously used across all industries, and its application methods also are rapidly being spread and distributed. For this, above all, tags should provide more functions.

Basically, a RFID system is configured with a tag and a reader for storing pertinent information and exchanging data by wireless protocols. Herein, the tag is divided into an active type and a passive type based on a power supply source. The active tag for receiving the power supply source from a battery decreases the power of the reader and increases recognition distance between it and the reader. On the other hand, the passive tag is purchased at low cost and may semi-permanently be used, but recognition distance is short and the amount of data capable of being stored increases.

### SUMMARY

In one general aspect, a locating system includes: an RFID tag outputting a first or second transmission message frame according to whether value added information exists; a plurality of readers receiving and analyzing the first or second transmission message frame to transmit extracted information and reception time information corresponding to the extracted information to a location processor, wherein the readers are disposed at different locations; and a location processor analyzing the information which is extracted through the readers and the reception time information to calculate location information or the value added information related to the RFID tag.

In another general aspect, a reader includes: a receiver receiving a first or second transmission message frame from a Radio Frequency Identification (RFID) tag according to whether value added information exists; and a controller analyzing the first or second transmission message frame to transmit extracted information and reception time information for locating.

In another general aspect, an RFID tag which interfaces with a plurality of readers for locating includes: a sensor module sensing value added information; and a processor module generating a first or second transmission message frame according to whether the sensor module senses the value added information, wherein each of the first and second transmission message frame includes information on Identification (ID) of the RFID tag.

In another general aspect, a driving method of an RFID tag which interfaces with a plurality of readers for locating includes: recognizing value added information which is sensed; and generating a first or second transmission message frame according to whether the sensed value added information exists, wherein each of the first and second transmission message frame includes information on ID of the RFID tag.

Other features and aspects will be apparent from the following detailed description, the drawings, and the claims.

### BRIEF DESCRIPTION OF THE DRAWINGS

FIG. 1 is a block diagram illustrating a real time locating system according to an exemplary embodiment.

FIG. 2A is a block diagram illustrating an RFID tag according to an exemplary embodiment.

FIG. 2B is a block diagram illustrating a reader according to an exemplary embodiment.

FIG. 3 is a flow chart for describing a driving method of an RFID tag according to an exemplary embodiment.

FIG. 4 is a conceptual view exemplarily illustrating a transmission message frame which is transmitted by an RFID tag according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

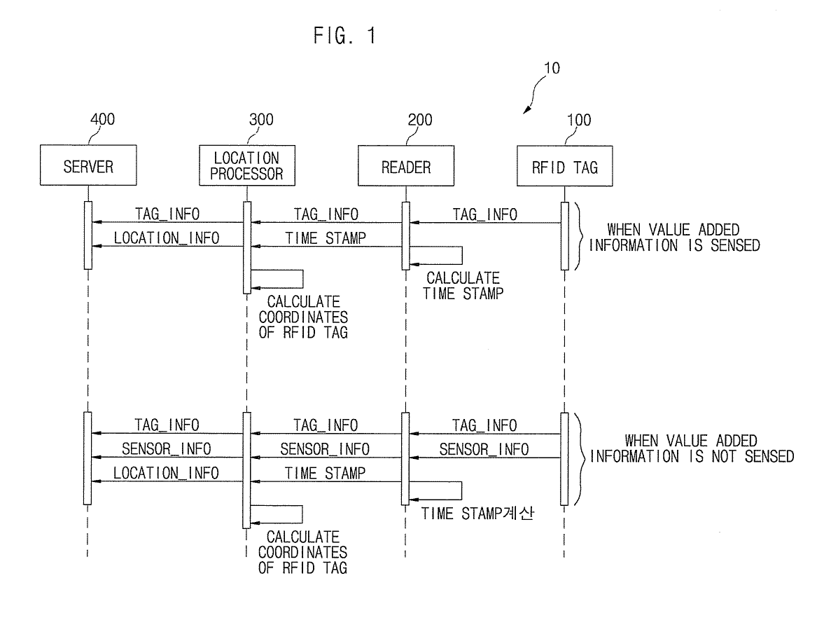

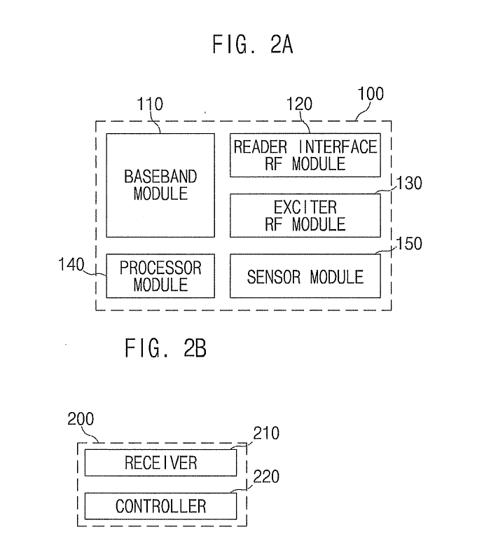

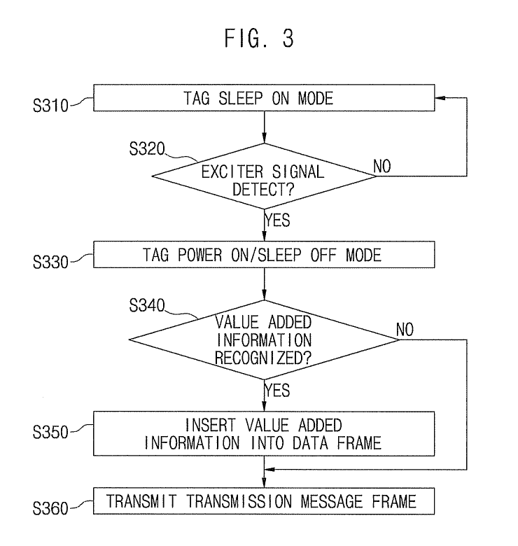

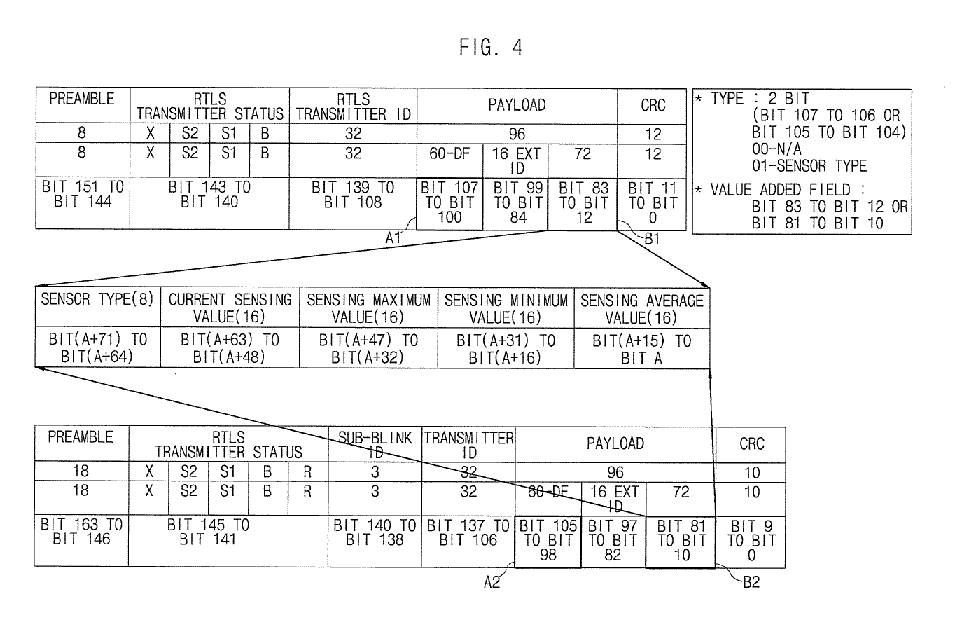

A real time locating system, an RFID tag and a driving method of the RFID tag according to an exemplary embodiment will be described below with reference to FIGS. 1 through 4. FIG. 1 is a block diagram illustrating a real time locating system according to an exemplary embodiment. FIG. 2A is a block diagram illustrating an RFID tag according to an exemplary embodiment. FIG. 2B is a block diagram illustrating a reader according to an exemplary embodiment. FIG. 3 is a flow chart for describing a driving method of an RFID tag according to an exemplary embodiment. FIG. 4 is a conceptual view exemplarily illustrating a transmission message frame which is transmitted by an RFID tag according to an exemplary embodiment.

Referring to FIG. 1, a real time locating system 10 according to an exemplary embodiment includes an RFID tag 100, a reader 200, a location processor 300, and a server 400. The overall operation of the real time locating system 10 may be different depending on a case in which the RFID tag 100 senses value added information and a case in which the RFID tag 100 does not sense value added information.

First, when the RFID tag 100 does not sense value added information, it is attached to products or objects to output tag information. For example, the RFID tag 100 may insert tag information into a data frame to output a first transmission message frame. Herein, the tag information may include information of ID for identifying the RFID tag 100. When the RFID tag 100 senses the value added information, it further inserts the value added information into the data frame to output a second transmission message frame. Herein, the value added information may denote information, which may be sensed from an object to which the RFID tag 100 is attached or the periphery of the object, for example, temperature, humidity, pulse frequency and blood pressure.

At least one reader 200 receives the first transmission message frame or the second transmission message frame. When a plurality of readers 200 are included, the respective readers 200 may be disposed at different locations.

When the at least one reader 200 receives the second transmission message frame having no value added information (when the RFID tag 100 does not sense the value added information), it analyzes the second transmission message frame to extract tag information and transmits the extracted tag information and the reception time information of the second transmission message frame corresponding to it to a location processor 300. Alternatively, the at least one reader 200 receives the first transmission message frame having the value added information (when the RFID tag 100 senses the value added information), it analyzes the first transmission message frame to extract tag information and the value added information and transmits the extracted tag information and value added information and the reception time information of the first transmission message frame corresponding to them to the location processor 300. The reader 200 calculates a Timestamp value on the basis of the reception time information, and the Timestamp value to the location processor 300.

The location processor 300 calculates the coordinates of the RFID tag 100 through a TDoA algorithm by using the Timestamp value which is received from the reader 200, and transfers the calculated coordinates and tag information to the server 400. When the RFID tag 100 senses the value added information, the location processor 300 further transmits the value added information to the server 400.

Specifically, when at least one transmission message frame for one tag is received through the plurality of readers 200, the location processor 300 may analyze the location of the RFID tag 100 on the basis of location information included in the first transmission message frame. Alternatively, when at least three or more transmission message frames for the RFID tag 100 are received, the location processor 300 may analyze the location of the RFID tag 100 through radiodetermination.

Herein, radiodetermination may be performed on the basis of reception time information when the reader 200 receives a transmission message frame. The principle for this is as follows.

Because the plurality of readers 200 spaced apart receive a transmission message frame which is broadcasted from the one RFID tag 100, a reader 200 that is relatively nearer to the RFID tag 100 first receives the transmission message frame, and a reader 200 that is relatively farther away from the RFID tag 100 receives the transmission frame later. At this point, when the absolute location information (coordinates) of the reader 200 is known in advance, the location of the RFID tag 100 may be analyzed through distance, which is calculated on the basis of the reception time information, between each of the readers 200 and the RFID tag 100.

The server 400 provides service to clients in accordance with all sorts of application fields on the basis of the tag information and the location coordinates of the RFID tag 100 or the value added information that are received from the location processor 300.

Hereinafter, the RFID tag 100 in FIG. 1 will be described in more detail with reference to FIG. 2A.

The RFID tag 100 includes a baseband module 110, a reader interface RF module 120, an exciter RF module 130, a processor module 140, and a sensor module 150.

The baseband module 110 modulates/demodulates a signal, and performs a modulation/demodulation function such as DSSS or CSS for expanding a transmission range for a transmission message signal.

The reader interface RF module 120 carries an encoding signal and a CRC carrier in a carrier frequency to transmit the carried signal and carrier to an antenna (not shown) through the baseband module 110.

The exciter RF module 130 receives a low frequency signal, which is outputted from an exciter (not shown), to transmit the received signal to the processor module 140. Herein, the exciter is included in a predetermined location and periodically outputs the low frequency signal for activating the RFID tag 100. For example, when intending to check the going in and out of an object, the exciter may be included in a gate and periodically output the low frequency signal. Alternatively, the exciter may be included near the reader 200 in which location may easily be checked.

The processor module 140 controls the baseband module 110, the reader interface RF module 120 and the exciter RF module 130. When an exciter signal is received from the exciter RF module 130, the processor module 140 generates a transmission message frame.

Hereinafter, the reader 200 in FIG. 1 will be described in more detail with reference to FIG. 2B.

The reader 200 includes a receiver 210 and a controller 220.

The receiver 210 receives the first transmission message frame or the second transmission message frame from the RFID tag 100

The controller 220 analyzes the first transmission message frame to extract tag information and the value added information and transmits the extracted tag information and value added information and the reception time information of the first transmission message frame to the location processor 300. And the controller analyzes the second transmission message frame to extract tag information and transmits the extracted tag information and the reception time information of the second transmission message to the location processor 300.

Hereinafter, an operation of the RFID tag 100 in FIG. 1 will be described in more detail with reference to FIG. 3.

Referring to FIG. 3, the RFID tag 100 normally is in a sleep mode, i.e., the minimum power consumption state in operation S210. In the sleep mode, the exciter RF module 130 of the RFID tag 100 continuously senses the existence of an exciter signal in operation S220. When the exciter signal is not sensed, the RFID tag 100 again enters into the sleep mode. When the exciter signal is sensed, the processor module 140 activates the RFID tag 100 to turn off the sleep mode in operation S230.

When the sensor module 150 senses value added information, i.e., when the processor module 140 recognizes the sensed value added information in operation 5240, the processor module 140 inserts the sensed value added information into a data frame to generate a first transmission message frame. At this point, the processor module 140 also inserts information on the ID of the RFID tag 100 into the data frame. When the sensed value added information does not exist, the processor module 140 inserts information on the ID of the RFID tag 100 into the data frame to generate a second transmission message frame.

The first transmission message frame or the second transmission message frame is modulated by the baseband module 110 and is transmitted to the reader 200 through the reader interface RF module 120 in operation 5260. Subsequently, the RFID tag 100 is changed into the sleep mode until the exciter signal is again sensed.

That is, the RFID tag 100 according to an exemplary embodiment may output the first transmission message frame including value added information and its own ID information when sensing the value added information. When the value added information is not received, the RFID tag 100 may output the second transmission message frame including only its own ID information.

Accordingly, the processor module 140 normally performs only the minimum operation for reducing power consumption, and then, when the exciter signal is received from the exciter RF module 130, the processor module 140 recognizes (or checks) the presence of the value added information by the sensor module 150, and consequently, it generates the first or second transmission message frame on the basis of corresponding information that is stored in a memory (not shown).

Hereinafter, the first or second transmission message frame that is generated by the processor module 140 will be described in more detail with reference to FIG. 4.

As an ISO 24730-21 type of frame structure, in FIG. 4, a transmission message frame structure illustrated in an upper portion represents a DSSS 152-bit message structure, and an ISO 24730-22 type of transmission message frame structure illustrated in a lower portion represents a DSSS 164-bit message structure. The first or second transmission message structure may be one of the DSSS 152-bit message structure and DSSS 164-bit message structure in FIG. 4. The DSSS 152-bit message structure and DSSS 164-bit message structure are illustrated as an example, and the present invention is not limited thereto.

Each of the first and second transmission message frames includes a preamble and the ID, payload and error correction code of the RFID tag 100. Moreover, as illustrated in FIG. 4, each of the first and second transmission message frames may further include a Real Time Locating System (RTLS) transmitter status, an RTLS transmitter ID, and a sub-blink. The sub-blink may be used to calculate the location of the RFID tag 100. Information and the size of each information unit that are included in the first or second transmission message frame may be varied according to the setting of protocols.

The first and second transmission message frames have a value added information flag, representing whether value added information exists, in a payload. For example, in FIG. 4, the first and second transmission message frames may be included in regions A1 and A2, respectively. As an example, when the value added information flag is “00”, a transmission message frame is the first transmission message frame and represents the non-existence of the value added information. When the value added information flag is “01”, a transmission message frame is the second transmission message frame and represents the existence of the value added information. When the value added information flag is inserted into the data frame of the DSSS 152-bit message structure, it may be inserted into a 107th bit and a 106th bit. Alternatively, when the value added information flag is inserted into the data frame of the DSSS 152-bit message structure, it may be inserted into a 105th bit and a 104th bit.

The controller 220 of the reader 200 may determine whether the received transmission message frame is the first or second transmission message frame through the value added information flag in the payload. When the received transmission message frame is the first transmission message frame, the reader 200 may extract the ID of the RFID tag 100 and value added information from the received transmission message frame and transmit the ID of the RFID tag 100, the value added information and reception time information corresponding to the ID of the RFID tag 100 to the location processor 300. Alternatively, when the received transmission message frame is the first transmission message frame, the reader 200 may transmit the ID of the RFID tag 100 and reception time information corresponding to the RFID tag 100 in the received transmission message frame to the location processor 300.

In FIG. 4, the ID of the RFID tag 100 and value added information may be included in regions B1 and B2 in a payload. For example, a sensor type representing the kind of the value added information and at least one of the current sensing value, sensing maximum value, sensing minimum value and sensing average value of the value added information may be inserted into the payload. When the value added information is inserted into the data frame of the DSSS 152-bit message structure, it may be inserted into an eighty-third bit to a twelfth bit. Alternatively, when the value added information is inserted into the data frame of the DSSS 152-bit message structure, it may be inserted into an eighty-first bit to a tenth bit.

In this way, in a DSSS message format, the value added information may be stored in a payload region being the existing reserved region.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A locating system, comprising:
a Radio Frequency Identification (RFID) tag outputting a first or second transmission message frame according to whether value added information exists;
a plurality of readers receiving and analyzing the first or second transmission message frame to transmit extracted information and reception time information corresponding to the extracted information to a location processor, wherein the readers are disposed at different locations; and
a location processor analyzing the information which is extracted through the readers and the reception time information to calculate location information or the value added information related to the RFID tag.

2. A reader, comprising:
a receiver receiving a first or second transmission message frame from a Radio Frequency Identification (RFID) tag according to whether value added information exists; and
a controller analyzing the first or second transmission message frame to transmit extracted information and reception time information for locating.

3. The reader of claim 2, wherein:
the receiver receives the first transmission message frame from the RFID tag when the value added information is sensed from an attached object, the first transmission message frame comprising the value added information and an Identification (ID) of the RFID tag, and
the receiver receives the second transmission message frame from the RFID tags when the value added information is not sensed, the second transmission message frame comprising the ID of the RFID tag.

4. The reader of claim 2, wherein:
each of the first and second transmission message frames comprises a preamble, the ID, payload and error correction code of the RFID tag, and
the first transmission message frame further comprises a sensor type representing a kind of the value added information, and at least one of a current sensing value, sensing maximum value, sensing minimum value and sensing average value of the value added information, in the payload.

5. The reader of claim 4, wherein each of the first and second transmission message frames further comprises a value added information flag representing whether the value added information exists, in the payload.

6. The reader of claim 5, wherein the controller analyzes the value added information flag in a payload region of the received first or second transmission message frame to determine whether the received transmission message frame is the first or second transmission message frame.

7. The reader of claim 6, wherein:
when the received transmission message frame is the first transmission message frame, the controller extracts the ID of the RFID tag and value added information from the received transmission message frame and transmits the ID of the RFID tag, the value added information and reception time information corresponding to the ID of the RFID tag, or
when the received transmission message frame is the first transmission message frame, the controller transmits the ID of the RFID tag and the reception time information corresponding to the ID of the RFID tag in the received transmission message frame.

8. A Radio Frequency Identification (RFID) tag which interfaces with a plurality of readers for locating, the RFID tag comprising:
a sensor module sensing value added information; and
a processor module generating a first or second transmission message frame according to whether the sensor module senses the value added information,
wherein each of the first and second transmission message frame comprises information on Identification (ID) of the RFID tag.

9. The RFID tag of claim 8, wherein:
the processor module outputs the first transmission message frame which comprises the value added information and the ID of the RFID tag, when the sensor module senses the value added information, and
the processor module outputs the second transmission message frame which comprises the ID of the RFID tag, when the value added information is not sensed.

10. The RFID tag of claim 9, wherein the processor module marks a value added information flag representing whether the value added information exists, in a payload of each of the first and second transmission message frames.

11. The RFID tag of claim 8, wherein:
each of the first and second transmission message frames comprises a preamble, the ID, payload and error correction code of the RFID tag, and
the first transmission message frame further comprises a sensor type representing a kind of the value added information, and at least one of a current sensing value, sensing maximum value, sensing minimum value and sensing average value of the value added information, in the payload.

12. The RFID tag of claim 8, further comprising:
an exciter RF module receiving a signal outputted from an exciter, and outputting the received signal to the processor module;
a baseband module modulating the first or second transmission message frame which is generated in the processor module; and
a reader interface RF module transmitting a signal which is generated in the baseband module.

13. A driving method of a Radio Frequency Identification (RFID) tag which interfaces with a plurality of readers for locating, the driving method comprising:
recognizing value added information which is sensed; and
generating a first or second transmission message frame according to whether the sensed value added information exists,
wherein each of the first and second transmission message frame comprises information on Identification (ID) of the RFID tag.

14. The driving method of claim 13, wherein the generating of a first or second transmission message frame comprises:
inserting the ID of the RFID tag and the value added information into a data frame to generate the first transmission message frame, when the sensed value added information exists; and
inserting the ID of the RFID tag into the data frame to generate the second transmission message frame, when the sensed value added information does not exist.

15. The driving method of claim 14, wherein the generating of a first or second transmission message frame further comprises inserting a value added information flag, which represents whether the value added information exists in a payload of each of the first and second transmission message frames, into each of the first and second transmission message frames.

16. The driving method of claim 13, wherein:
each of the first and second transmission message frames comprises a preamble, the ID, payload and data region for error correction of the RFID tag, and
the first transmission message frame further comprises a sensor type representing a kind of the value added information, and at least one of a current sensing value, sensing maximum value, sensing minimum value and sensing average value of the value added information, in the payload.

17. The driving method of claim 13, further comprising:
transmitting the generated first or second transmission message frame; and
changing into a sleep mode when the exciter signal is not sensed.
